(19) United States
(12) Patent Application Publication
(10) Pub. No.: US 2026/0154446 A1
(43) Pub. Date: Jun. 4, 2026

(54) SYSTEMS AND METHODS FOR ISOLATING PROGRAMS IN RUNTIME AND DETERMINING SECURITY VULNERABILITIES

(71) Applicant: BANK OF AMERICA CORPORATION, Charlotte, NC (US)

(72) Inventors: Manu Jacob Kurian, Dallas, TX (US); Harinath Meedinti Bhaskara Reddy, Harrisburg, NC (US); Swagata Banerjee, Maharastra (IN); Pavan Gulhane, Oakville (CA)

(73) Assignee: BANK OF AMERICA CORPORATION, Charlotte, NC (US)

(21) Appl. No.: 18/965,275

(22) Filed: Dec. 2, 2024

(51) Int. Cl. G06F 21/62

(52) U.S. Cl. CPC G06F 21/6254

(57) ABSTRACT

A system is provided for isolating programs in runtime and determining security vulnerabilities. In particular, the system may comprise a protector AI engine that may analyze code of programs and applications at runtime within a virtualized or sandbox environment. The system may further provide obfuscated or decoy data to the code within the sandbox environment, where the obfuscated data may be quantum generated. The system may further comprise one or more patch AI bots that may be configured to generate patches or fixes to particular code blocks in real time upon detecting that the code blocks may be vulnerable. In this way, the system may detect and remedy security vulnerabilities in real time.

### TECHNOLOGICAL FIELD

Example embodiments of the present disclosure relate to a system for isolating programs in runtime and determining security vulnerabilities.

### BACKGROUND

There is a need for an intelligent and efficient way to identify security vulnerabilities in applications, computing devices, and networks.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for isolating programs in runtime and determining security vulnerabilities. In particular, the system may comprise a protector AI engine that may analyze code of programs and applications at runtime within a virtualized or sandbox environment. The system may further provide obfuscated or decoy data to the code within the sandbox environment, where the obfuscated data may be quantum generated. The system may further comprise one or more patch AI bots that may be configured to generate patches or fixes to particular code blocks in real time upon detecting that the code blocks may be vulnerable. In this way, the system may detect and remedy security vulnerabilities in real time.

Accordingly, embodiments of the present disclosure provide a system for isolating programs in runtime and determining security vulnerabilities, the system comprising: a processing device; a non-transitory storage device containing instructions when executed by the processing device, cause the processing device to perform the steps of: analyzing, using a protector artificial intelligence (“AI”) engine, a set of code deployed to a computing environment; cloning the set of code into a virtualized environment; providing an obfuscated data set to the set of code within the virtualized environment; detecting, using the protector AI engine, one or more problematic code blocks within the set of code in the virtualized environment; and executing one or more remediation steps on the set of code in the virtualized environment based on detecting the one or more problematic code blocks.

In some embodiments, the set of code is analyzed by the protector AI engine at runtime.

In some embodiments, the obfuscated data set is generated using a quantum processor of a quantum computing device, wherein generating the obfuscated data set comprises anonymizing a data set containing sensitive data.

In some embodiments, the one or more problematic code blocks comprise potentially malicious code, wherein the one or more remediation steps comprise: deleting the set of code within the virtualized environment; and preventing execution of the set of code deployed to the computing environment.

In some embodiments, the one or more problematic code blocks comprise potentially malicious code, wherein the one or more remediation steps comprise: detecting that the set of code within the virtualized environment is attempting to exfiltrate at least a portion of the obfuscated data set to an unauthorized computing device; and severing a network connection between the set of code within the virtualized environment and the unauthorized computing device.

In some embodiments, the one or more remediations step comprise: generating, using a quantum computing device, a fix for the one or more problematic code blocks; and dynamically applying the fix to the set of code deployed to the computing environment in real time.

In some embodiments, the one or more remediation steps are executed automatically in response to detecting the one or more problematic code blocks.

Embodiments of the present disclosure also provide a computer program product for isolating programs in runtime and determining security vulnerabilities, the computer program product comprising a non-transitory computer-readable medium comprising code causing an apparatus to perform the steps of: analyzing, using a protector artificial intelligence (“AI”) engine, a set of code deployed to a computing environment; cloning the set of code into a virtualized environment; providing an obfuscated data set to the set of code within the virtualized environment; detecting, using the protector AI engine, one or more problematic code blocks within the set of code in the virtualized environment; and executing one or more remediation steps on the set of code in the virtualized environment based on detecting the one or more problematic code blocks.

In some embodiments, the set of code is analyzed by the protector AI engine at runtime.

In some embodiments, the obfuscated data set is generated using a quantum processor of a quantum computing device, wherein generating the obfuscated data set comprises anonymizing a data set containing sensitive data.

In some embodiments, the one or more problematic code blocks comprise potentially malicious code, wherein the one or more remediation steps comprise: deleting the set of code within the virtualized environment; and preventing execution of the set of code deployed to the computing environment.

In some embodiments, the one or more problematic code blocks comprise potentially malicious code, wherein the one or more remediation steps comprise: detecting that the set of code within the virtualized environment is attempting to exfiltrate at least a portion of the obfuscated data set to an unauthorized computing device; and severing a network connection between the set of code within the virtualized environment and the unauthorized computing device.

In some embodiments, the one or more remediations step comprise: generating, using a quantum computing device, a fix for the one or more problematic code blocks; and dynamically applying the fix to the set of code deployed to the computing environment in real time.

Embodiments of the present disclosure also provide a computer-implemented method for isolating programs in runtime and determining security vulnerabilities, the computer-implemented method comprising: analyzing, using a protector artificial intelligence (“AI”) engine, a set of code deployed to a computing environment; cloning the set of code into a virtualized environment; providing an obfuscated data set to the set of code within the virtualized environment; detecting, using the protector AI engine, one or more problematic code blocks within the set of code in the virtualized environment; and executing one or more remediation steps on the set of code in the virtualized environment based on detecting the one or more problematic code blocks.

In some embodiments, the set of code is analyzed by the protector AI engine at runtime.

In some embodiments, the obfuscated data set is generated using a quantum processor of a quantum computing device, wherein generating the obfuscated data set comprises anonymizing a data set containing sensitive data.

In some embodiments, the one or more problematic code blocks comprise potentially malicious code, wherein the one or more remediation steps comprise: deleting the set of code within the virtualized environment; and preventing execution of the set of code deployed to the computing environment.

In some embodiments, the one or more problematic code blocks comprise potentially malicious code, wherein the one or more remediation steps comprise: detecting that the set of code within the virtualized environment is attempting to exfiltrate at least a portion of the obfuscated data set to an unauthorized computing device; and severing a network connection between the set of code within the virtualized environment and the unauthorized computing device.

In some embodiments, the one or more remediations step comprise: generating, using a quantum computing device, a fix for the one or more problematic code blocks; and dynamically applying the fix to the set of code deployed to the computing environment in real time.

In some embodiments, the one or more remediation steps are executed automatically in response to detecting the one or more problematic code blocks.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for isolating programs in runtime and determining security vulnerabilities, in accordance with an embodiment of the disclosure;

FIG. 2 illustrates an exemplary quantum optimizer, in accordance with an embodiment of the disclosure;

FIG. 3 illustrates an exemplary generative AI subsystem architecture, in accordance with an embodiment of the disclosure; and

FIG. 4 illustrates a method for isolating programs in runtime and determining security vulnerabilities, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

As used herein, “quantum computing” or “quantum computing system” may refer to computing processes and/or a computer that utilizes the principles of quantum physics to perform computational operations. Several variations of quantum computer design are known, including photonic quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2n states simultaneously. By comparison, a classical computer can only be in one of the 2n states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three-qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present disclosure may harness the quantum ability of optimization by utilizing a quantum computer in conjunction with a classical computer. Such a configuration allows the system to benefit from the quantum speedup in solving optimization problems, while avoiding the drawbacks and difficulty of implementing quantum computing to perform non-optimization calculations. Examples of quantum computers that can be used to solve optimization problems parallel to a classic system are described in, for example, U.S. Pat. Nos. 9,400,499, and 9,207,672, each of which is incorporated herein by reference in its entirety.

A modern entity's network environment may be highly complex and large, the network environment may encompass a large number of programs and applications, which may be incorporated into complicated workflows. The increase in the number of running programs and applications may be accompanied with the technical challenge of detecting whether such programs and applications are vulnerable or have become compromised (e.g., through malware injections, on-path attacks, and/or the like). The challenges may further be exacerbated when the programs and applications have already been deployed to the production environment and are currently running to perform their intended functions. Accordingly, there is a need for a secure and efficient way to identify and remediate security vulnerabilities in programs and applications.

To address the above concerns among others, embodiments of the disclosure may provide a system for isolating programs in runtime and determining security vulnerabilities. The system may comprise a protector AI engine that may be configured to analyze the code of the programs and/or applications in the network environment in real time, at run time, and/or during execution, to identify and respond to potential threats such as on-path attacks or malicious code injections. In this regard, the protector AI engine may clone the code of the programs and or applications and execute the cloned code within a virtualized or sandbox environment, where the virtualized or sandbox environment may comprise the computing resources (e.g., virtualized processors, memory space, storage space, network bandwidth, operation systems, libraries, applications, and/or the like) for executing the cloned code. In this way, the system may monitor the actions taken by the code without exposing the main operational environment (e.g., the production environment) to possible harm, thereby providing an added layer of security against potentially harmful code.

In some embodiments, the system may include functionality to provide only obfuscated data to the sandbox environment, where the obfuscated data may be used and processed by the program instead of “live” or “production” data. For instance, instead of transmitting potentially sensitive data (e.g., personally identifiable information, or “PII”) directly into the sandbox environment, the system may send obfuscated or anonymized versions of data into the sandbox environment, effectively masking sensitive information while still enabling the code to perform its intended functions. In such a scenario, to the extent that the sandboxed program contains potentially unauthorized or malicious code (e.g., code that attempts to exfiltrate data from the computing environment), the system may preempt the compromise of the sensitive data through the use of the obfuscated data. In some embodiments, the obfuscated data may be quantum-generated (e.g., generated using quantum computing devices), allowing the system to generate a large range of obfuscated datasets to test the sandboxed code simultaneously or in near real time.

In the event that the system identifies suspicious code blocks within the sandboxed code (e.g., the code blocks contain malware) or detects that the code attempts to transmit sensitive information (e.g., to an unauthorized third party device), the protector AI engine may intervene by taking one or more remediation steps to address the suspicious code. For instance, the remediation steps may include withdrawing or deleting the code from the sandbox, or by severing the network connection of the sandboxed code to external applications or devices. The system may then prevent the execution of the program within the production environment and/or isolate the program from the production environment, thereby preventing the problematic code from being executed in the main operating environment. In some embodiments, execution of the remediation steps may occur automatically in response to predefined threat indicators, allowing the system to act quickly to prevent potential breaches.

In some embodiments, the remediation steps may include applying fixes to the potentially problematic code blocks or portions within the analyzed program. In this regard, the system may further comprise one or more patch AI bots that are configured to address vulnerabilities in real time as they are identified. The patch AI bots may use computational processes such as qubit superposition and entanglement to determine optimal fixes for problematic code blocks. By employing such quantum-based technologies, the patch AI bots may dynamically identify problematic portions and generate fixes or patches “on-the-fly,” thereby implementing the fixes in real time or near real time. In this way, the system's responsiveness to emerging threats may be increased.

The system as disclosed herein provides a number of technological advantages over conventional systems for detecting vulnerabilities in computer programs. For instance, by using a quantum computing-based obfuscated data generation process, the system may be able to generate large data sets of obfuscated data to be processed by sandboxed programs such that the programs (e.g., programs that process large amounts of data) may be tested in a realistic manner within the virtual environment. Furthermore, by using the quantum processing-based patch AI bots, the system may expediently and efficiently identify and apply patches to potentially problematic code within the analyzed programs, which in turn may allow the production environments to continue to operate with minimal interruption or downtime.

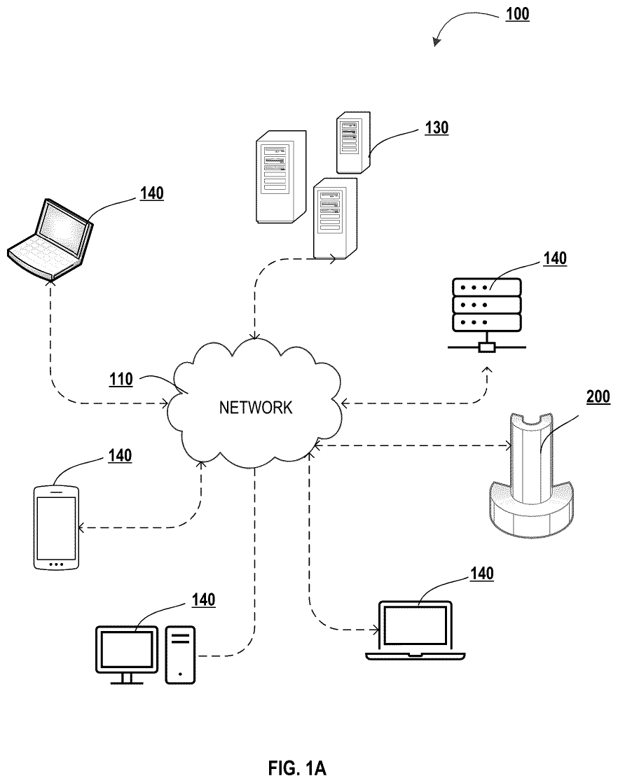

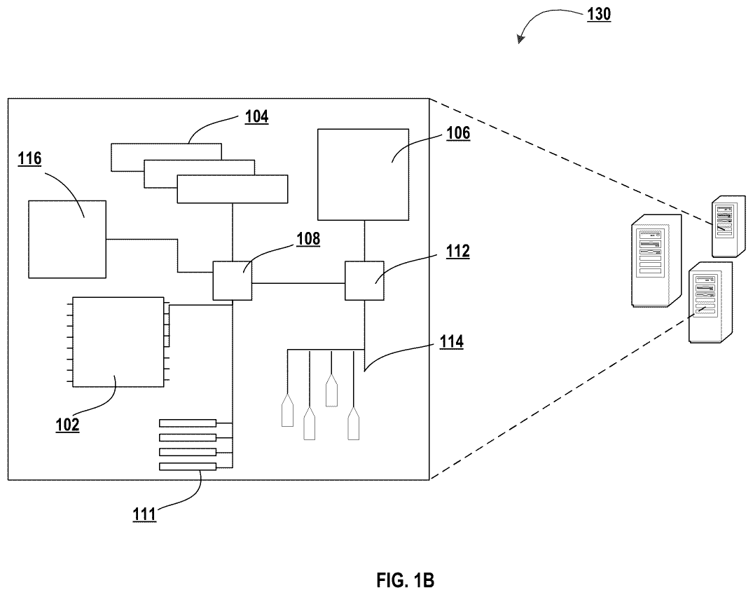

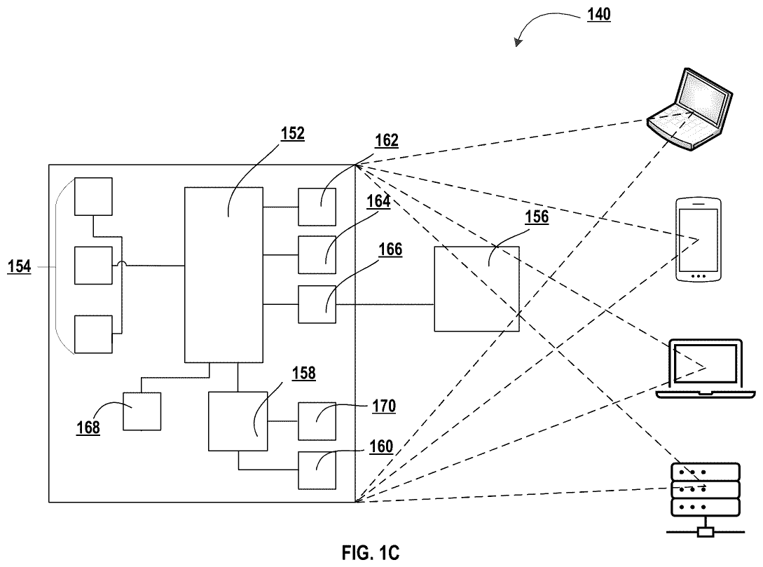

Turning now to the figures, FIGS. 1A-1C illustrate technical components of an exemplary distributed computing environment 100 for the system for isolating programs in runtime and determining security vulnerabilities. As shown in FIG. 1A, the distributed computing environment 100 contemplated herein may include a cloud computing security system 130, an end-point device(s) 140, and a network 110 over which the cloud computing security system 130 and end-point device(s) 140 communicate therebetween. In some embodiments, the cloud computing security system 130 and/or the endpoint device(s) 140 may be communicatively coupled to a quantum optimizer 200. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to cloud computing security system 130, with each system providing portions of the necessary operations (e.g., as a server bank, a group of blade servers, or a multi-processor system).

In some embodiments, the cloud computing security system 130, the quantum optimizer 200, and the end-point device(s) 140 may have a client-server relationship in which the end-point device(s) 140 are remote devices that request and receive service from a centralized server, i.e., the cloud computing security system 130. In some other embodiments, the cloud computing security system 130, the quantum optimizer 200, and the end-point device(s) 140 may have a peer-to-peer relationship in which the cloud computing security system 130 and the end-point device(s) 140 are considered equal and all have the same abilities to use the resources available on the network 110. Instead of having a central server (e.g., cloud computing security system 130) which would act as the shared drive, each device that is connect to the network 110 would act as the server for the files stored on it. In some embodiments, the cloud computing security system 130 may provide an application programming interface (“API”) layer for communicating with the end-point device(s) 140.

The cloud computing security system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The quantum optimizer 200 may represent a quantum computing system that may be used to execute quantum computing operations. Accordingly, as part of the overall system, the quantum optimizer 200 may perform quantum computations in concert with the conventional computing operations executed by the cloud computing security system 130 and/or the endpoint device(s) 140.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the cloud computing security system 130 may be separated into two or more distinct portions.

FIG. 1B illustrates an exemplary component-level structure of the cloud computing security system 130, in accordance with an embodiment of the invention. As shown in FIG. 1B, the cloud computing security system 130 may include a processor 102, memory 104, input/output (I/O) device 116, and a storage device 110. The cloud computing security system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., cloud computing security system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the cloud computing security system 130 using any subsystems described herein. It is to be understood that the cloud computing security system 130 may use, as appropriate, multiple processors, along with multiple memories, and/or I/O devices, to execute the processes described herein.

The memory 104 stores information within the cloud computing security system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the cloud computing security system 130 during operation.

The storage device 106 is capable of providing mass storage for the cloud computing security system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the cloud computing security system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The cloud computing security system 130 may be implemented in a number of different forms. For example, it may be implemented as a standard server, or multiple times in a group of such servers. Additionally, the cloud computing security system 130 may also be implemented as part of a rack server system or a personal computer such as a laptop computer. Alternatively, components from cloud computing security system 130 may be combined with one or more other same or similar systems and an entire cloud computing security system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the cloud computing security system 130 via the network 110. Any communication between the cloud computing security system 130 and the end-point device(s) 140 may be subject to an authentication protocol allowing the cloud computing security system 130 to maintain security by permitting only authenticated users (or processes) to access the protected resources of the cloud computing security system 130, which may include servers, databases, applications, and/or any of the components described herein. To this end, the cloud computing security system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the cloud computing security system 130 (or other client devices) permissioned access to the protected resources of the end-point device(s) 140, which may include a GPS device, an image capturing component (e.g., camera), a microphone, and/or a speaker.

The end-point device(s) 140 may communicate with the cloud computing security system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the cloud computing security system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the cloud computing security system 130.

Various implementations of the distributed computing environment 100, including the cloud computing security system 130 and end-point device(s) 140, and techniques described here can be realized in digital electronic circuitry, integrated circuitry, specially designed ASICs (application specific integrated circuits), computer hardware, firmware, software, and/or combinations thereof.

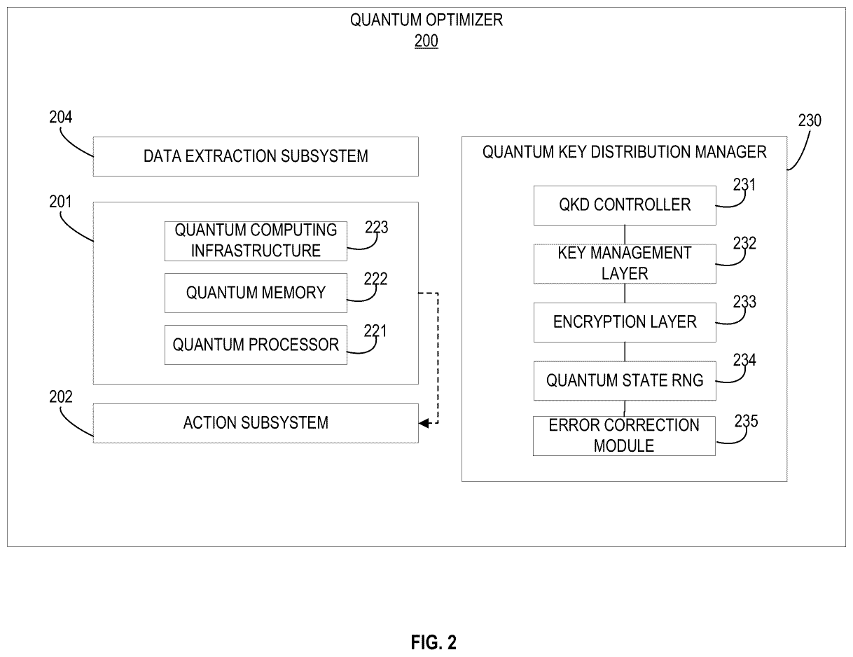

FIG. 2 is a schematic diagram of an exemplary quantum optimizer 200, in accordance with one embodiment of the invention. It is understood that quantum optimizer 200 can be used in parallel with a classical computer to solve optimization problems. The quantum optimizer 200 is comprised of a data extraction subsystem 204, a quantum computing subsystem 201, and an action subsystem 205. As used herein, the term “subsystem” generally refers to components, modules, hardware, software, communication links, and the like of particular components of the system. Subsystems as contemplated in embodiments of the present invention are configured to perform tasks within the system as a whole.

The data extraction subsystem 204 communicates with the cloud computing security system 130 to extract data for optimization. It will be understood that any method of communication between the data extraction subsystem 204 and the network 101 includes, but is not limited to wired communication, Radiofrequency (RF) communication, Bluetooth®, Wi-Fi, and the like. The data extraction subsystem 204 then formats the data for optimization in the quantum computing subsystem, such as converting data into qubits.

The quantum computing subsystem 201 may comprise a quantum computing infrastructure 223, a quantum memory 222, and a quantum processor 221. The quantum computing infrastructure 223 comprises physical components for housing the quantum processor 221 and the quantum memory 222. The quantum computer infrastructure 223 further comprises a cryogenic refrigeration system to keep the quantum computing subsystem 201 at the desired operating conditions. In general, the quantum processor 221 is designed to perform adiabatic quantum computation and/or quantum annealing to optimize data received from the data extraction subsystem 204. The quantum memory 222 is comprised of a plurality of qubits used for storing data during operation of the quantum computing subsystem 201. In general, qubits are any two-state quantum mechanical system. It will be understood that the quantum memory 222 may be comprised of any such two-state quantum mechanical system, such as the polarization of a single photon, the spin of an electron, and the like.

The action subsystem 202 communicates the optimized data from the quantum computing subsystem 201 back to the data monitoring system 106. It will be understood that any method of communication between the data extraction subsystem 204 and the network 101 includes, but is not limited to wired communication, Radiofrequency (RF) communication, Bluetooth, Wi-Fi, and the like.

The quantum optimizer 200 may further comprise a quantum key distribution manager 230 that controls the encryption of the target data using the QKD algorithm. In particular, the quantum key distribution manager 230 may comprise one or more hardware and/or software components, which may include a QKD controller 231, a key management layer 232, an encryption layer 233, and a quantum state random number generator (“QSRNG”) 234. The QKD controller 231 may control and/or orchestrate the encryption of the target data (e.g., by communicating with the intelligent data orchestrator over a network). The encryption layer 233 performs the quantum algorithm-based encryption of the target data by receiving two random digital sequences (e.g., RSA₁ and RSA₂) from the QSRNG 234. Based on the two random sequences, the encryption layer 233 may generate a random string of qubits that may then be used to encrypt the target data. The key management layer 232 may exist between the QKD controller 231 and the encryption layer 233 to perform de-multiplexing of bits such that the target data may be accessed and used by the various endpoint devices and/or the applications associated therewith. In some embodiments, the quantum key distribution manager 230 may further comprise an error correction module 235 that may perform an error correction process to remove errors and/or data leakage that may occur during the encryption process.

In accordance with the present systems and methods, an on-board quantum optimizer may be employed to perform encryption and decryption functions quickly and more reliably than a classical digital computing system. Because a quantum computing device inherently performs optimization in its natural evolution, quantum optimizer is particularly well-suited to solve optimization problems and process large swaths of incoming real-time data (e.g., the target data received from the endpoint devices).

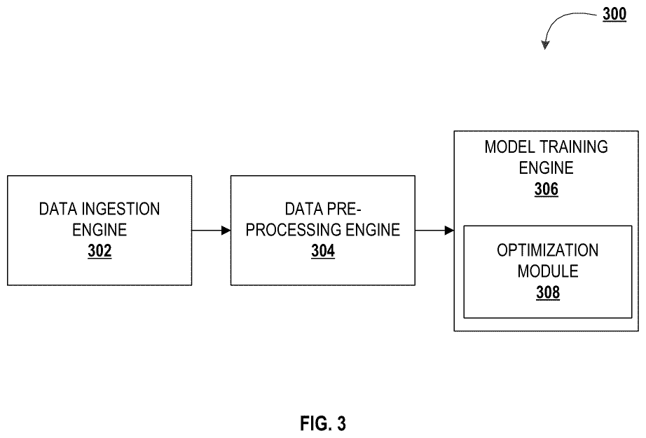

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the data sources may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that are programmed for certain applications and may transmit data over the internet or other networks, and/or the like.

Depending on the nature of the data, the data ingestion engine 302 may move the data to a destination for storage or further analysis. Typically, the data may be in varying formats as the data comes from different sources, including RDBMS, other types of databases, S3 buckets, CSVs, or from streams. For a large language model (“LLM”), text data may originate from sources such as web scrapes, social media, large public text datasets, or the like. Since the data may come from different places, the data needs to be cleansed and transformed so that the data may be analyzed together with data from other sources. The data may be ingested in real-time, using stream processing, in batches using a batch data warehouse, or in a combination of both. Stream processing may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse may collect and transfer data in batches according to scheduled intervals, triggered events, and/or any other logical ordering.

The generative AI subsystem 300 may utilize one or more machine learning techniques to generate new content. In machine learning, the quality of data and the useful information that may be derived therefrom directly affects the ability of the machine learning model to learn. The data pre-processing engine 304 may implement advanced integration and processing steps needed to prepare the data for machine learning execution, including tokenization, text normalization, and/or removal of irrelevant elements like HTML tags in web-based data, especially for LLM training. This may include modules to perform any upfront data transformation to consolidate the data into alternate forms by changing the value, structure, and/or format of the data by using generalization, normalization, attribute selection, aggregation, and text-specific transformations such as stemming and lemmatization to data clean by filling missing values, smoothing the noisy data, resolving the inconsistency, removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that may be suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training engine 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, and/or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data may be used to update the model's parameters, while the validation and testing datasets may be reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as creativity, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

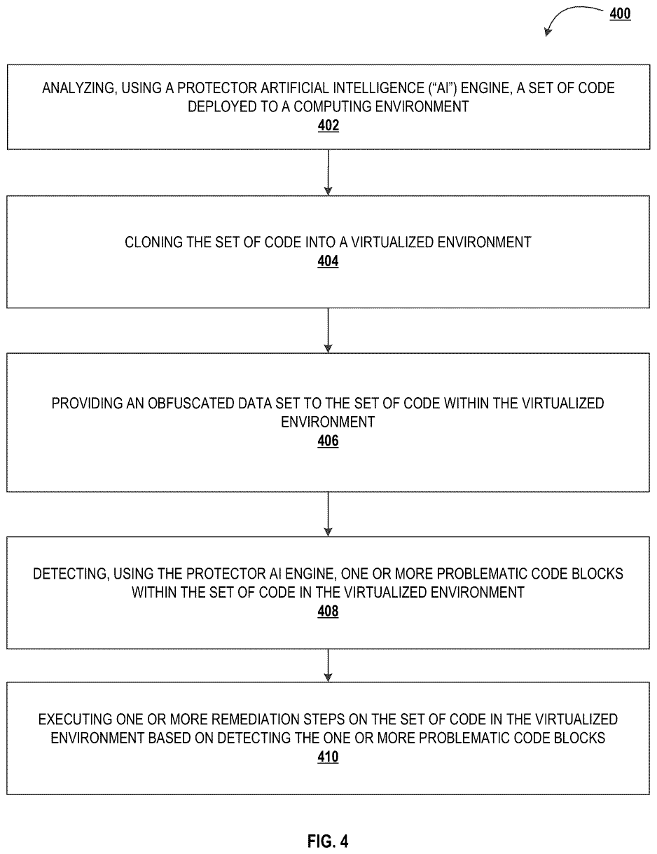

FIG. 4 illustrates a method 400 for isolating programs in runtime and determining security vulnerabilities. As shown in block 402, the method includes analyzing, using a protector artificial intelligence (“AI”) engine, a set of code deployed to a computing environment. The set of code may be, for instance, a computer program or application that has been deployed to a live or production environment. The protector AI engine may be an engine that has been trained to recognize anomalous or potentially problematic patterns in the execution, behaviors, and/or other characteristics of computer programs. In this regard, the protector AI engine may be configured to detect instances in which programs may become compromised through unintentional circumstances (e.g., data corruption, system failures, and/or the like) and/or unauthorized or malicious access or modification (e.g.,, malware injections, on-path attacks, and/or the like).

Next, as shown in block 404, the method includes cloning the set of code into a virtualized environment. The virtualized environment may be a virtual computing environment that comprises the computing resources needed to run the cloned set of code. In some embodiments, the cloning or copying of the set of code into the virtualized environment and/or analysis of the set of code may be executed at the program's runtime. In this regard, the operation of the program within the production environment may be halted until the program has been evaluated within the virtualized environment.

Next, as shown in block 406, the method includes providing an obfuscated data set to the set of code within the virtualized environment. The obfuscated data set may be generated, for instance, by anonymizing or sanitizing an existing data set (e.g., application data that may be processed by the program during the ordinary course of its operation) to remove potentially sensitive information (e.g., PII) from the data set.

Next, as shown in block 408, the method includes detecting, using the protector AI engine, one or more problematic code blocks within the set of code in the virtualized environment.

Next, as shown in block 410, the method includes executing one or more remediation steps on the set of code in the virtualized environment based on detecting the one or more problematic code blocks.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for isolating programs in runtime and determining security vulnerabilities, the system comprising:
a processing device;
a non-transitory storage device containing instructions when executed by the processing device, cause the processing device to perform the steps of:
analyzing, using a protector artificial intelligence (“AI”) engine, a set of code deployed to a computing environment;
cloning the set of code into a virtualized environment;
providing an obfuscated data set to the set of code within the virtualized environment;
detecting, using the protector AI engine, one or more problematic code blocks within the set of code in the virtualized environment; and
executing one or more remediation steps on the set of code in the virtualized environment based on detecting the one or more problematic code blocks.

2. The system of claim 1, wherein the set of code is analyzed by the protector AI engine at runtime.

3. The system of claim 1, wherein the obfuscated data set is generated using a quantum processor of a quantum computing device, wherein generating the obfuscated data set comprises anonymizing a data set containing sensitive data.

4. The system of claim 1, wherein the one or more problematic code blocks comprise potentially malicious code, wherein the one or more remediation steps comprise:
deleting the set of code within the virtualized environment; and
preventing execution of the set of code deployed to the computing environment.

5. The system of claim 1, wherein the one or more problematic code blocks comprise potentially malicious code, wherein the one or more remediation steps comprise:
detecting that the set of code within the virtualized environment is attempting to exfiltrate at least a portion of the obfuscated data set to an unauthorized computing device; and
severing a network connection between the set of code within the virtualized environment and the unauthorized computing device.

6. The system of claim 1, wherein the one or more remediations step comprise:
generating, using a quantum computing device, a fix for the one or more problematic code blocks; and
dynamically applying the fix to the set of code deployed to the computing environment in real time.

7. The system of claim 1, wherein the one or more remediation steps are executed automatically in response to detecting the one or more problematic code blocks.

8. A computer program product for isolating programs in runtime and determining security vulnerabilities, the computer program product comprising a non-transitory computer-readable medium comprising code causing an apparatus to perform the steps of:
analyzing, using a protector artificial intelligence (“AI”) engine, a set of code deployed to a computing environment;
cloning the set of code into a virtualized environment;
providing an obfuscated data set to the set of code within the virtualized environment;
detecting, using the protector AI engine, one or more problematic code blocks within the set of code in the virtualized environment; and
executing one or more remediation steps on the set of code in the virtualized environment based on detecting the one or more problematic code blocks.

9. The computer program product of claim 8, wherein the set of code is analyzed by the protector AI engine at runtime.

10. The computer program product of claim 8, wherein the obfuscated data set is generated using a quantum processor of a quantum computing device, wherein generating the obfuscated data set comprises anonymizing a data set containing sensitive data.

11. The computer program product of claim 8, wherein the one or more problematic code blocks comprise potentially malicious code, wherein the one or more remediation steps comprise:
deleting the set of code within the virtualized environment; and
preventing execution of the set of code deployed to the computing environment.

12. The computer program product of claim 8, wherein the one or more problematic code blocks comprise potentially malicious code, wherein the one or more remediation steps comprise:
detecting that the set of code within the virtualized environment is attempting to exfiltrate at least a portion of the obfuscated data set to an unauthorized computing device; and
severing a network connection between the set of code within the virtualized environment and the unauthorized computing device.

13. The computer program product of claim 8, wherein the one or more remediations step comprise:
generating, using a quantum computing device, a fix for the one or more problematic code blocks; and
dynamically applying the fix to the set of code deployed to the computing environment in real time.

14. A computer-implemented method for isolating programs in runtime and determining security vulnerabilities, the computer-implemented method comprising:
analyzing, using a protector artificial intelligence (“AI”) engine, a set of code deployed to a computing environment;
cloning the set of code into a virtualized environment;
providing an obfuscated data set to the set of code within the virtualized environment;
detecting, using the protector AI engine, one or more problematic code blocks within the set of code in the virtualized environment; and
executing one or more remediation steps on the set of code in the virtualized environment based on detecting the one or more problematic code blocks.

15. The computer-implemented method of claim 14, wherein the set of code is analyzed by the protector AI engine at runtime.

16. The computer-implemented method of claim 14, wherein the obfuscated data set is generated using a quantum processor of a quantum computing device, wherein generating the obfuscated data set comprises anonymizing a data set containing sensitive data.

17. The computer-implemented method of claim 14, wherein the one or more problematic code blocks comprise potentially malicious code, wherein the one or more remediation steps comprise:
deleting the set of code within the virtualized environment; and
preventing execution of the set of code deployed to the computing environment.

18. The computer-implemented method of claim 14, wherein the one or more problematic code blocks comprise potentially malicious code, wherein the one or more remediation steps comprise:
detecting that the set of code within the virtualized environment is attempting to exfiltrate at least a portion of the obfuscated data set to an unauthorized computing device; and
severing a network connection between the set of code within the virtualized environment and the unauthorized computing device.

19. The computer-implemented method of claim 14, wherein the one or more remediations step comprise:
generating, using a quantum computing device, a fix for the one or more problematic code blocks; and
dynamically applying the fix to the set of code deployed to the computing environment in real time.

20. The computer-implemented method of claim 14, wherein the one or more remediation steps are executed automatically in response to detecting the one or more problematic code blocks.
